(19) United States
(12) Patent Application Publication
(10) Pub. No.: US 2009/0152783 A1
(43) Pub. Date: Jun. 18, 2009

(54) Post holder

(76) Inventors: Derek L. Sigler, Atoka, TN (US); Tommy L. Sigler, Atoka, TN (US); Beverly Jo Sigler, Atoka, TN (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/000,848

(22) Filed: Dec. 18, 2007

(51) Int. Cl. B25B 11/00

(52) U.S. Cl. 269/6; 269/287

(57) ABSTRACT

The post holder is a hinged clamp mechanism having three hinge plates, including a back plate and two side plates. The two side plates are hinged to opposite edges of the back plate, and can be folded to form a hollow triangular prism open at both ends and secured by inserting a locking hinge pin through aligned knuckles along the edges of the side plates. Elongated, rod-shaped handles extend from the side plates. The back plate has spaced slots defined therein adapted for engaging studs protruding from a T-post. The locking hinge pin may be tethered to one of the plates, and handgrips may cushion the ends of the handles.

### BACKGROUND OF THE INVENTION

1. Field of the Invention

The present invention relates to fence installation devices, and more particularly to a post holder for holding a T-post while the T-post is being driven into the ground.

2. Description of the Related Art

It is a common chore for ranchers, farmers and homeowners to install fencing on their property. One of the most well-known and economical styles of fencing is a wire fence supported at spaced intervals by posts having a generally T-shaped configuration. Such posts are typically made of steel and have protrusions, sometimes referred to as nodules, studs or nubs, which are spaced at intervals along the post. The bottom end of the post is usually driven into the earth with a sledgehammer forcibly brought down upon the upper end. The wire fencing may be barbed wire, a wire mesh, chicken wire, or other suitable fencing material, which may be attached to the posts by clips, wire ties, welding, or other methods.

When driving the post, it must be held steady and in position by hand to ensure proper contact and uprightness as the first few blows are administered. This creates a dangerous situation that may result in injury in the event a driver misses the post and strikes the hand of an assistant holding the post. The force of the blows also causes vibrations and shimmying of the post that are uncomfortable at best, and may leave a residual tingling in the hands and arms after the installation of a long stretch of fencing. Anticipation or fear that the driver may miss the post and strike the assistant's hands and residual tingling from the force of repeated blows may cause the assistant's hands to shake or slip on the post, with the result that the post hole is too wide to firmly support the post in an upright position, so that the post may wobble or may be pushed over upon the application of moderate force by a horse, cow, or other animal penned in by the fence.

An alternative to a sledgehammer is a tubular post-driving member that telescopes over a post and acts as a hammer and confining guide. When the tube is forcibly brought down upon the upper end of the post, the driver is halted upon contact with a blunt end. The post must still be steadied by hand during the first few blows, making the person holding the post susceptible to gashes, cuts, and potential blunt injury from the post driver.

Other conventional methods to protect a holder's hand include wearing gloves, tying the post to stakes, or by digging a guide hole. Nevertheless, gloves afford little protection are still vulnerable to shard and vibrations and the other methods may require additional tools or are laborious and time-consuming.

Thus, a post holder solving the aforementioned problems is desired.

### SUMMARY OF THE INVENTION

The post holder is a hinged clamp mechanism having three hinge plates, including a back plate and two side plates. The two side plates are hinged to opposite edges of the back plate, and can be folded to form a hollow triangular prism open at both ends and secured by inserting a locking hinge pin through aligned knuckles along the edges of the side plates. Elongated, rod-shaped handles extend from the side plates. The back plate has spaced slots defined therein adapted for engaging studs protruding from a T-post. The locking hinge pin may be tethered to one of the plates, and handgrips may cushion the ends of the handles.

In use, the slots in the back plate are placed over nodules on the T-post to prevent the post holder from sliding up and down, and the side plates are folded around the T-post to align the hinge knuckles. The locking hinge pin is inserted through the knuckles to clamp the T-post, and the assistant grasps the handgrips at the ends of the handles to hold the T-post steady as the T-post is driven into the ground.

These and other features of the present invention will become readily apparent upon further review of the following specification and drawings.

### BRIEF DESCRIPTION OF THE DRAWINGS

FIG. 1 is an environmental perspective view of a post holder according to the present invention, shown clamped onto a T-post while a T-post installer is driving the post.

FIG. 2 is an environmental perspective view of the post holder according to the present invention, shown with an open hinge and the locking hinge pin tethered to one of the side plates.

FIG. 3 is an environmental perspective view of the post holder according to the present invention, shown clamped about a T-post.

FIG. 4 is a perspective view of the post holder according to the present invention, shown in an open position as seen from the back plate.

FIG. 5 is a partial perspective view of the post holder according to the present invention, shown in a closed position.

Similar reference characters denote corresponding features consistently throughout the attached drawings.

### DETAILED DESCRIPTION OF THE PREFERRED EMBODIMENTS

The present invention relates to a post holder, designated generally as 15 in the drawings, that is used to steady a post P, particularly a T-post, when the post is being driven into the ground. The post holder 15 is preferably made of steel, but can be made of any suitable metal alloy, rigid composite, or other rigid, durable, strong material.

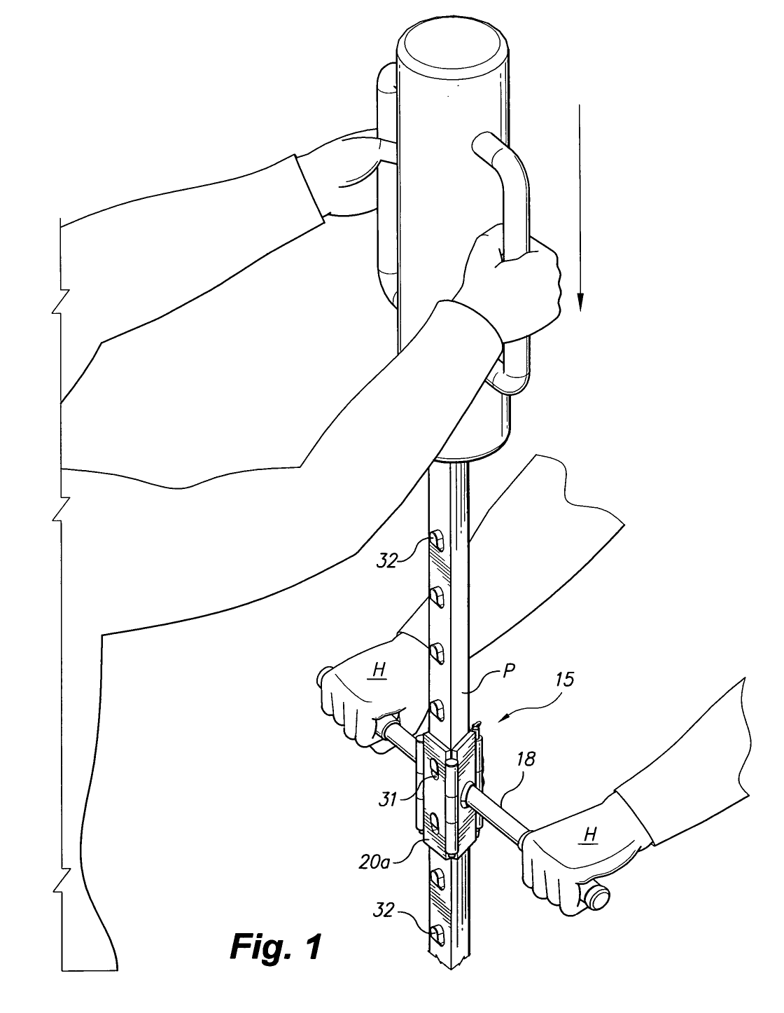

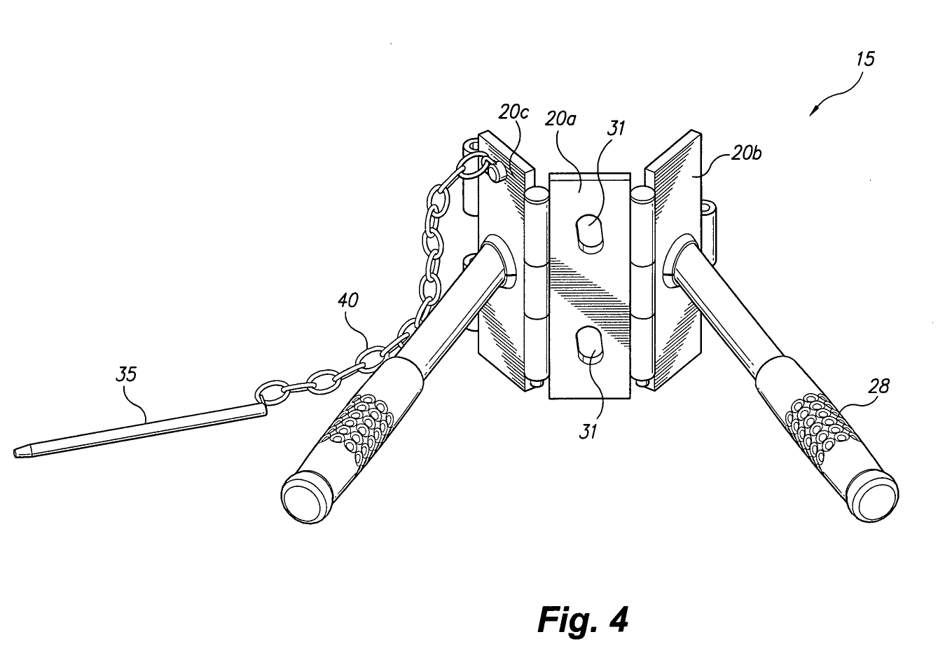

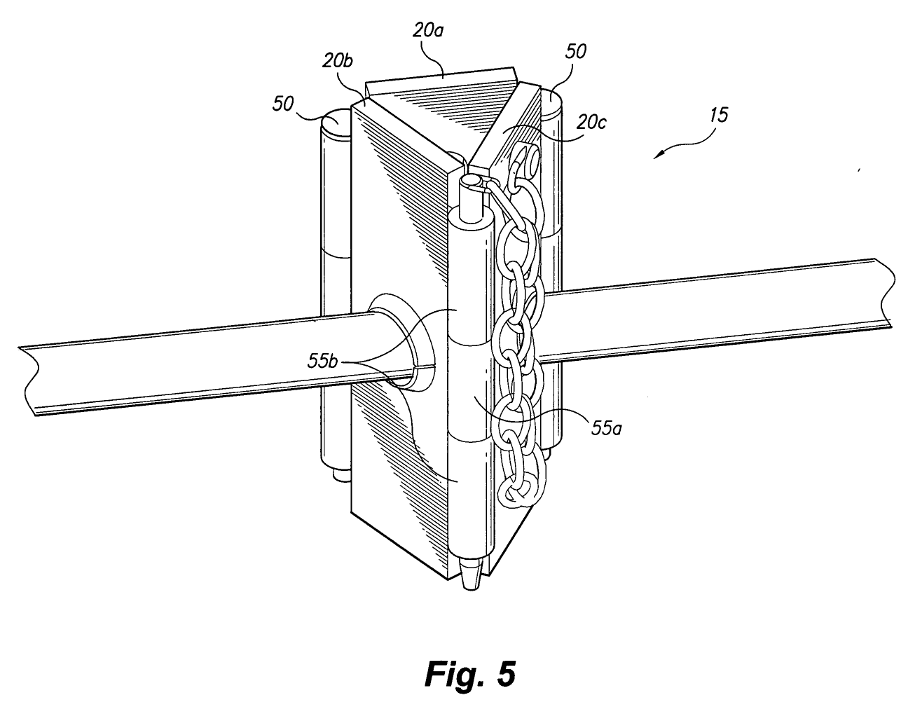

Referring first to FIGS. 4 and 5, the post holder 15 is formed from three hinge plates, including a back plate 20a and two side plates 20b and 20c. The side plates 20b and 20c are pivotally attached to back plate 20a by hinge pins 50, which may be fixed or non-removable from the corresponding hinge joints. As shown in FIGS. 1, 4, and 5, side plates 20b and 20c may be spread apart to an open position and then folded to a closed position forming a hollow triangular prism at both ends that can be clamped around a post P, particularly a studded T-post. In the closed position, knuckles 55a and 55b, which extend from the edges of side plates 20b and 20c, respectively, are aligned to form a tubular hinge joint 55 that can be locked together by inserting locking hinge pin 35 through the aligned knuckles 55a, 55b. The knuckles 55a,55b may be replaced with locking magnets, a buckle, a clip or similar releasable locking mechanisms.

Elongated, rod-shaped handles 18 extend from side plates 20b and 20c, and are substantially collinear when the side plates 20b, 20c are folded to the closed position. Handgrips 28, which may be made from natural or synthetic rubber or other resilient material, may cushion the ends of the handles 18. Handles 28 may be welded to plates 20b, 20c, or may releasably snap or thread into sockets, adapters, or other fittings attached to the plates 20b, 20c. The back plate 20a may have spaced apart slots 31 or holes defined therein adapted for engaging nodules protruding from a T-post P. The locking hinge pin 35 may be attached to one of the hinge plates by a tether, such as a chain 40, a rope, or other elongated flexible member.

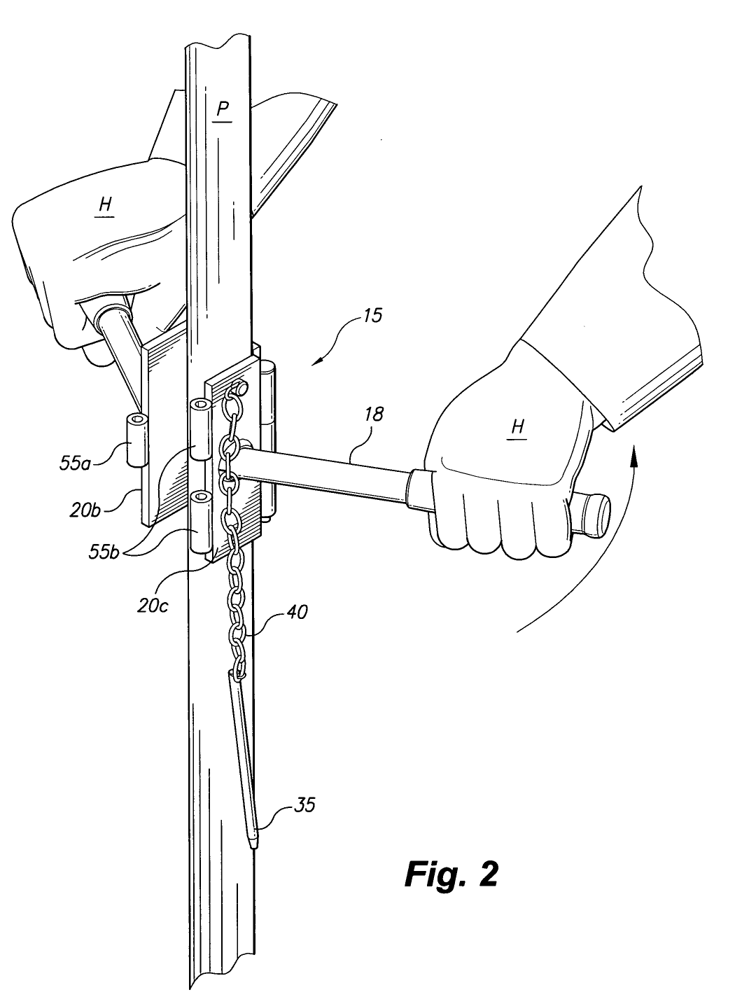

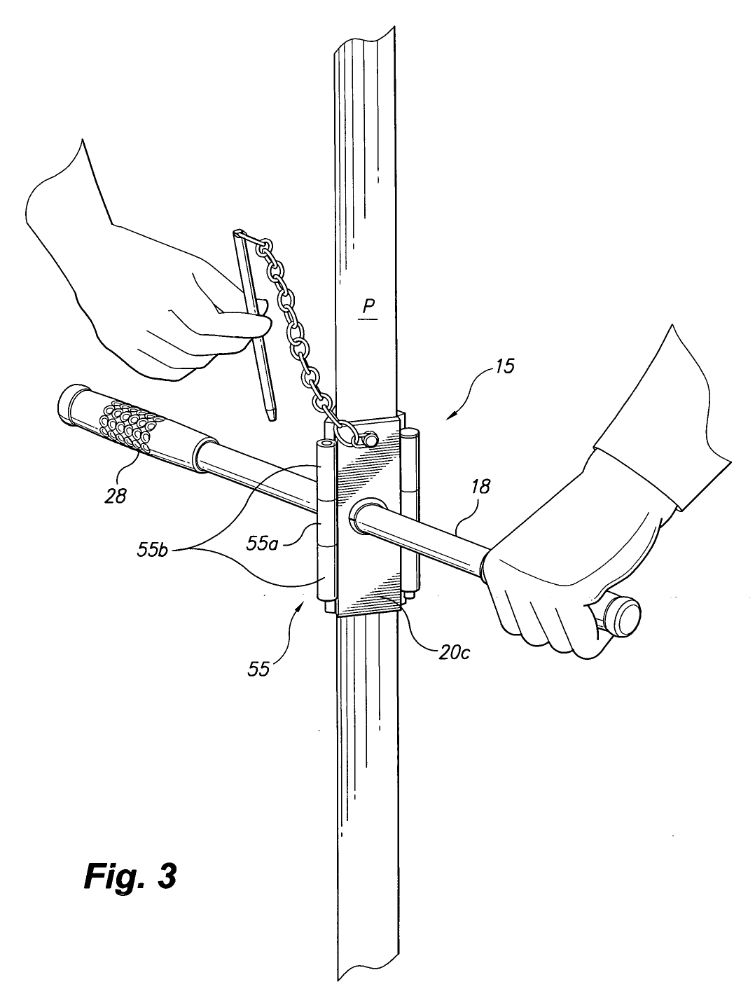

In use, the side plates 20b and 20c may be spread apart to place the post holder 15 around a post P, as shown in FIG. 2. Preferably, the slots 31 in the back plate 20a are aligned with nodules 32 that protrude from the T-post P, as shown in FIG. 1, the nodules engaging the slots 31 in order to prevent the post holder 15 from sliding up and down on the post P. The side plates 20b and 20c may then be pivoted towards each other to align knuckles 55a, 55b, forming a tubular hinge joint 55, as shown in FIG. 3. The locking hinge pin 35 is then inserted into the hinge joint formed by knuckles 55a, 55b to lock the plates 20b, 20c together, clamping the post holder 15 to the T-post P.

As shown in FIG. 1, the assistant may then grasp the handgrips 28 with his hands H to hold the post steady while the post P is being driven into the ground. The handles 18 are long enough that the assistant's hands H are far enough from the post P that the risk of injury from a blow to the hands H is greatly reduced. Further, cushioning provided by handgrips 28 reduces discomfort from vibrations as the blows are struck. The handles 28 provide enough leverage from opposite sides of the post P that the assistant is able to hold the post P quite steady during installation of the post P, assuring a straighter post P more rigidly fixed in the ground compared to holding post P directly with the hands. The assistant may grasp the handles while facing back plate 20a, or while facing the hinge joint formed by plates 20b, 20c opposite plate 20a. Post holder 15 may also be used when pulling post P out of the ground, if desired.

It is to be understood that the present invention is not limited to the embodiments described above, but encompasses any and all embodiments within the scope of the following claims.

We claim:

1. A post holder, comprising:
a back plate and two side plates pivotally attached to opposing edges of the back plate, the two side plates being pivotal between an open position and a closed position in which the plates form a hollow triangular prism open at both ends adapted for closely enclosing a post in the closed position;
hinge knuckles extending from edges of the side plates, the hinge knuckles being aligned to form a tubular hinge joint when the plates are pivoted to the closed position;
a locking hinge pin removably insertable into the tubular hinge joint in order to clamp the plates around the post; and
an elongated handle extending from each of the side plates, the handles extending in opposite directions when the plates are pivoted to the closed position.

2. The post holder according to claim 1, further comprising a handgrip disposed on each of the handles opposite the side plates.

3. The post holder according to claim 2, wherein each said handgrip is made from a resilient material.

4. The post holder according to claim 2, wherein each said handgrip is made from rubber.

5. The post holder according to claim 2, wherein each said handgrip is cushioned.

6. The post holder according to claim 1, further comprising a tether attaching the locking hinge pin to one of said plates.

7. The post holder according to claim 1, further comprising a chain attaching the locking hinge pin to one of said plates.

8. The post holder according to claim 1, wherein said back plate has at least one slot defined therein adapted for engaging a nodule protruding from the post in order to prevent the plates from sliding up and down on the post.

9. The post holder according to claim 8, wherein said at least one slot comprises a pair of slots.

10. A post holder, comprising:
a back plate and two side plates pivotally attached to opposing edges of the back plate, the two side plates being pivotal between an open position and a closed position in which the plates form a hollow triangular prism open at both ends adapted for closely enclosing a post in the closed position;
an elongated handle extending from each of the side plates, the handles extending in opposite directions when the plates are pivoted to the closed position; and
means for temporarily locking the plates in the closed position in order to clamp the plates around the post.

11. The post holder according to claim 10, wherein said means for temporarily locking the plates in the closed position comprises:
hinge knuckles extending from edges of the side plates, the hinge knuckles being aligned to form a tubular hinge joint when the plates are pivoted to the closed position; and
a locking hinge pin removably insertable into the tubular hinge joint in order to clamp the plates around the post.

12. The post holder according to claim 11, further comprising a tether attaching the locking hinge pin to one of said plates.

13. The post holder according to claim 11, further comprising a chain attaching the locking hinge pin to one of said plates.

14. The post holder according to claim 10, further comprising a handgrip disposed on each of the handles opposite the side plates.

15. The post holder according to claim 14, wherein each said handgrip is made from a resilient material.

16. The post holder according to claim 14, wherein each said handgrip is made from rubber.

17. The post holder according to claim 14, wherein each said handgrip is cushioned.

18. The post holder according to claim 10, wherein said back plate has at least one slot defined therein adapted for engaging a nodule protruding from the post in order to prevent the plates from sliding up and down on the post.

19. The post holder according to claim 18, wherein said at least one slot comprises a pair of slots.

20. A post holder, comprising:
a back plate and two side plates pivotally attached to opposing edges of the back plate, the two side plates being pivotal between an open position and a closed position in which the plates form a hollow triangular prism open at both ends adapted for closely enclosing a post in the closed position, the back plate having a pair of slots defined therein adapted for engaging nodules protruding from the post in order to prevent the plates from sliding up and down the post;
hinge knuckles extending from edges of the side plates, the hinge knuckles being aligned to form a tubular hinge joint when the plates are pivoted to the closed position;
a locking hinge pin removably insertable into the tubular hinge joint in order to clamp the plates around the post;
an elongated handle extending from each of the side plates, the handles extending in opposite directions when the plates are pivoted to the closed position;
a cushioned handgrip disposed on each of the handles opposite the side plates; and
a tether attaching the locking hinge pin to one of the plates.
